(19) United States
(12) Patent Application Publication
(10) Pub. No.: US 2026/0180072 A1
(43) Pub. Date: Jun. 25, 2026

(54) ENERGY SUPPLY DEVICE WITH A TEMPERING APPARATUS AND METHOD FOR SETTING A TEMPERATURE OF AN ENERGY SUPPLY DEVICE

(71) Applicant: ANDREAS STIHL AG & Co. KG, Waiblingen (DE)

(72) Inventors: Armin GERBER, Waiblingen (DE); Nicolai SARTORIUS, Stuttgart (DE); Florian KLEIN, Esslingen am Neckar (DE); Sebastian SCHENK, Schorndorf (DE); Christian UHLMANN, Erlangen (DE)

(73) Assignee: ANDREAS STIHL AG & Co. KG, Waiblingen (DE)

(21) Appl. No.: 19/426,255

(22) Filed: Dec. 19, 2025

(30) Foreign Application Priority Data
Dec. 23, 2024 (DE) 10 2024 139 587.7

(51) Int. Cl. H01M 10/6566; H01M 10/613; H01M 10/6235; H01M 10/647; H01M 50/211; H01M 50/247

(52) U.S. Cl. CPC H01M 10/6566; H01M 10/613; H01M 10/6235; H01M 10/647; H01M 50/211; H01M 50/247; H01M 2220/30

(57) ABSTRACT

There is an energy supply device comprising: a cell unit for receiving and/or delivering electrical energy in an operating state of the energy supply device. The cell unit comprises a first connection element and a second connection element, which transmit electrical energy; a tempering apparatus for tempering the cell unit via a medium flow (MS) in a channel which guides the medium flow (MS) along at least one flow direction. The tempering apparatus forms, a first coupling with the first connection element and a second coupling with the second connection element, and is configured to galvanically separate from each other the first connection element and the second connection element between the first coupling and the second coupling via an insulating section of the channel, to avoid electrical contacting of the first and second connection elements. There is also a method for setting the temperature of an energy supply device.

### CROSS REFERENCE TO RELATED APPLICATIONS

This application claims priority under 35 U.S.C. § 119 of German Application No. DE 10 2024 139 587.7, filed on Dec. 23, 2024, the disclosure of which is incorporated by reference. The international application under PCT article 21(2) was not published in English.

### DESCRIPTION

The present invention lies in the field of electrical energy supply technology and relates to an energy supply device, in particular for an electric tool. The present invention also relates to a method for setting, in particular regulating and/or controlling, a temperature of an energy supply device.

A rechargeable electrical energy supply device, for example in the form of a mobile, exchangeable battery pack with a plurality of cell units (abbreviated to “cells”), is typically characterized by a defined temperature range within which the efficiency of charging or discharging is increased and, for example, aging effects can be reduced.

In order to realize proper or intended functioning of the energy supply device, defined temperature threshold values should not be exceeded. It is therefore desirable to always operate such an energy supply device within an optimal temperature range.

For this purpose, for example, when charging the energy supply device by means of a charging device during a charging process, a cooling unit is used which supplies the energy supply device with an air flow in order to remove a generated heat from the energy supply device by means of the air flow. This ensures that the energy supply device does not heat up unnecessarily during the charging process, which also shortens the cooling time. The cooling unit is typically formed as a fan unit with an impeller in order to generate the air flow for cooling the energy supply device.

In order to start a charging process for an energy supply device with cell units in the 18650 format, a corresponding temperature must be present. In the case of cell modules with cylindrical cell units (“round cells”), a sufficiently high through-flow with an air flow can be realized between the cell units for removing the generated heat.

For energy supply devices with so-called pouch cells, a cooling concept based on an air flow may no longer be sufficient, especially if higher charging currents are to be realized during the charging process.

On the other hand, in certain situations it can also be necessary to heat the energy supply device and thus the cell units instead of cooling, at least for a defined period of time.

It is an object of the present invention to provide an energy supply device, which is characterized above all by an improved tempering concept, in particular during charging processes with comparatively high charging currents. Furthermore, it is an object of the present invention to provide an improved method for setting a temperature of an energy supply device.

The object is solved by the features of independent claims 1 and 15. Further embodiments and applications of the present invention are apparent from the dependent claims and are explained in more detail in the following description with partial reference to the figures.

The present invention relates, from a first general point of view, to an energy supply device, in particular for an electric tool, comprising: at least one cell unit for receiving and/or delivering electrical energy in an operating state of the energy supply device, wherein the at least one cell unit comprises a first connection element and a second connection element, which are configured for providing an electrical potential and/or for transmitting electrical energy; a tempering apparatus, in particular a cooling apparatus, for tempering the at least one cell unit by means of a medium flow in at least one channel which is configured to guide the medium flow along at least one flow direction, wherein the tempering apparatus forms, in each case in a thermally conductive manner, a first coupling with the first connection element and a second coupling with the second connection element, and is configured to galvanically separate from each other the first connection element and the second connection element between the first coupling and the second coupling by means of at least one insulating section of the at least one channel, in order to avoid electrical contacting of the first and second connection elements.

With the present invention, an energy supply device can be provided which ensures a charging process with comparatively high charging currents and/or is characterized by comparatively short cooling times after a usage phase, i.e., after discharging, since the cooling capacity can be significantly increased by means of the tempering apparatus, for example. Alternatively, in addition to a cooling, a heating of the at least one cell unit can also be realized by means of the tempering apparatus using the medium flow. The at least one cell unit can be formed in particular as a pouch cell, wherein the first connection element forms a first cell tab and the second connection element forms a second cell tab. The first and second connection elements are formed in particular on the basis of an electrically conductive material, which is additionally characterized by a comparatively high thermal conductivity. The electrically conductive material can be aluminum or copper or a respective alloy based on aluminum and/or copper. The at least one channel of the tempering apparatus can be divided into several channel sections produced separately. In particular, the first coupling can be formed by a first channel section of the at least one channel with the first connection element and the second coupling by a second channel section of the at least one channel with the second connection element. With the exception of the insulating section, the at least one channel can be formed from a metallic material which is characterized by a comparatively high thermal conductivity. This can further improve a transfer and/or a transmission of generated heat to the medium flow located in the at least one channel. It is possible to reverse the flow direction for the medium flow. The medium flow can be realized by means of a flowable and/or liquid medium. Furthermore, a flow velocity and/or a dynamic pressure of the medium flow can be set differently.

The medium flow can be generated by a charging device connected to the energy supply device, so that the medium flow passes through the energy supply device for removing generated heat and through the charging device for cooling. The medium flow can be a circulating medium flow.

Due to the arrangement of the insulating section of the at least one channel of the tempering apparatus and the associated galvanic separation between the first connection element and the second connection element, the at least one channel can be formed, in particular in the area of the connection elements, on the basis of a metallic material in order to realize a high thermal conductivity at the couplings, while at the same time avoiding the generation of a short circuit between the connection elements of the at least one cell unit. With the at least one insulating section, a potential separation can be realized.

The present invention makes in particular use of the heat-conducting properties of the connection elements, i.e., the cell tabs of the at least one cell unit, to realize a cooling or a heating of the at least one cell unit with the aid of a tempering apparatus using a medium flow. A heating can be useful, for example, when the at least one cell unit is formed as a solid-state battery and/or during charging processes at comparatively cold ambient temperatures of the energy supply device, for example winter temperatures, in order to enable the energy supply device to be charged comparatively quickly.

It is possible that the at least one insulating section is configured to be electrically insulating and/or extends along the at least one flow direction between the first coupling and the second coupling with a defined length.

The at least one insulating section can be produced from an insulating material with inherent electrical insulating properties and resulting insulating capabilities. The defined length can be dimensioned such that, with regard to the use of different medium flows, the establishment of an electrically conductive connection between the first coupling and the second coupling is avoided. The defined length can depend on a voltage, in particular on a double value of a voltage, of the cell unit.

According to a further aspect of the present invention, it can be provided that the at least one insulating section is formed integrally in one piece on the basis of an electrically insulating material (insulating material), wherein, in particular, the electrically insulating material is additionally a thermally insulating material.

The at least one insulating section can be produced by at least one of the following processes: a casting process, an injection process, a sintering process, a 3D printing process, a curing process, a shrinking process.

By using an additional thermally insulating material, for example, an unwanted heat transfer from the at least one insulating section can be essentially avoided.

According to a further aspect of the present invention, it can be provided that the at least one insulating section is formed to be sectionally variable in shape, in particular reversibly deformable, along the at least one flow direction in order to essentially compensate for a volume work of the medium flow.

This allows, for example, volume expansion effects resulting due to different volume expansion coefficients of respective channel sections of the at least one channel formed of metallic material to be essentially neutralized.

It is possible that the at least one insulating section is arranged and/or formed to change, in particular to deflect, the flow direction, wherein, in particular, the at least one insulating section is formed curved.

This can particularly take into account a configuration with several cell units arranged adjacent to one another, wherein the at least one channel extends along these several cell units.

According to a further aspect of the present invention, it can be provided that a flow cross-section of the at least one insulating section varies along the flow direction, in particular decreases in sections and/or increases in sections, in each case depending on an arrangement of the at least one cell unit relative to at least one further and/or adjacent cell unit.

For example, a flow cross-section of the at least one insulating section, which is arranged between two adjacent cell units, can be smaller than a flow cross-section of the at least one insulating section, which is arranged outside the cell units.

By varying the flow cross-section, a flow velocity and/or a dynamic pressure of the medium flow can be passively controlled at defined locations in order to realize a desired heat transfer.

It is possible that the first coupling and/or the second coupling each comprise an essentially material bonded connection, in particular a connection produced by a welding process, a soldering process, and/or an adhesive process.

The first coupling and/or the second coupling can thus be realized by a comparatively simple and quick assembly process.

According to a further aspect of the present invention, it can be provided that the at least one insulating section is connected, against the flow direction upstream and/or in the flow direction downstream, in each case by means of an essentially material bonded connection to a respective connection section of the at least one channel, in particular by means of an adhesive connection.

This allows a sufficient, essentially gas-tight and/or liquid-tight connection to be realized between the at least one insulating section and further channel sections of the at least one channel in a metallic material design.

It is possible that at least one channel section of the at least one channel, in particular for forming the first coupling and/or the second coupling, is configured to generate a turbulent medium flow in order to increase an introduction of a quantity of heat and/or a removal of generated heat at the first connection element and/or at the second connection element.

According to a further aspect of the present invention, it can be provided that at least one guide element for generating the turbulent medium flow is arranged and/or formed within the at least one channel, which extends in particular along the flow direction, wherein, in particular, four guide elements are arranged within the at least one channel, which are characterized in a cross-sectional view of the at least one channel by a sectionally cross-shaped contour.

The at least one guide element can be configured to generate turbulent flow conditions within the medium flow, wherein, in turn, an improved transfer of heat to the medium flow can be realized, for example. The at least one guide element can be arranged within the at least one channel upstream of the flow direction, in front of the first coupling and/or the second coupling. In addition or alternatively, the at least one guide element can also be arranged and/or formed in the area of or opposite to the coupling in the at least one channel. Accordingly, in addition to an essentially laminar medium flow, a turbulent medium flow can also be realized additionally and in particular locally limited.

According to a further aspect of the present invention, it can be provided that the at least one guide element and at least one further guide element are arranged and/or formed along the flow direction opposite to each other and/or offset relative to each other, wherein, in particular, the at least one guide element is formed as at least one of the following: a fin, a lamella, a blade.

The at least one guide element can influence the medium flow in favour of the transfer and removal of heat as a passively acting guide element. Furthermore, a heat transfer can be realized at defined locations by the at least one guide element and the associated defined increase in surface area.

It is possible that the at least one channel, in particular the at least one insulating section, and at least the first coupling and the second coupling are arranged and/or embedded within a carrier material structure, which is formed essentially dimensionally stable, integrally one-piece and/or electrically insulating, and/or which is produced by at least one of the following processes: an injection process, a casting process, a curing process, a shrinking process, wherein, in particular, the carrier material structure is formed on the basis of a resin material.

As a result, for example, an embedding of at least a part of the at least one channel can be realized, which, for example, makes additional retaining elements for the at least one channel unnecessary.

A charge management unit as disclosed herein can be arranged on the carrier material structure, wherein, for example, a cooling of the charge management unit can also be realized at the same time by means of the tempering apparatus, i.e., the at least one channel in connection with the medium flow.

According to a further aspect of the present invention, it can be provided that the energy supply device comprises a plurality of cell units, each with a first connection element and a second connection element, which, in particular, are arranged adjacent to one another in stacking direction, wherein, depending on the arrangement of the respective first connection element and the respective second connection element, the at least one channel comprises, along the flow direction, in sections at least one of the following configurations: meandering, comb-shaped, spiral-shaped, zigzag-shaped, wave-shaped, and/or stepped.

In other words, the at least one channel of the tempering apparatus can be characterized by a meandering, comb-shaped, spiral-shaped, zigzag-shaped, wave-shaped, and/or stepped course and an associated respective flow direction for the medium flow in order to realize a removal of heat as required.

According to a further aspect of the present invention, the energy supply device can comprise a plurality of cell units, each with a first connection element and a second connection element, which are arranged in a stacking direction adjacent to each other to form a cell pack with opposing outer sides, wherein the at least one channel is arranged and formed so that the flow direction runs from at least one centrally arranged cell unit to at least one of the outer sides.

As a result, for example, heat generated especially at centrally arranged cell units of the energy supply device can be removed, which can be subjected to higher thermal stress by adjacent cell units.

The present invention relates, from a second general point of view, to a method for setting, in particular regulating and/or controlling, a temperature of an energy supply device with at least one cell unit for receiving and/or delivering electrical energy in an operating state of the energy supply device, wherein the at least one cell unit comprises a first connection element and a second connection element, which are configured for providing an electrical potential and/or for transmitting electrical energy; and with a tempering apparatus, in particular a cooling apparatus, for tempering the at least one cell unit, which comprises at least one channel for guiding a medium flow along a flow direction, wherein the tempering apparatus forms, in each case in a thermally conductive manner, a first coupling with the first connection element and a second coupling with the second connection element, and galvanically separates from each other the first connection element and the second connection between the first coupling and the second coupling by means of at least one insulating section of the at least one channel, wherein the medium flow is introduced into the at least one channel in order to dissipate generated heat of the first connection element and/or the second connection element through the medium flow along the flow direction or to introduce a quantity of heat in order to set a defined temperature of the energy supply device, in particular of the at least one cell unit, wherein, in particular, the energy supply device is configured as disclosed herein.

To avoid repetition, features directed purely at the apparatus of the energy supply device according to the invention and/or disclosed in connection therewith shall also be deemed to be disclosed as part of the method and shall be claimable, and vice versa.

The embodiments and features of the present invention described above can be combined with each other in any manner or as appropriate. Further or other details and advantageous effects of the present invention are explained in more detail below with reference to the accompanying figures.

It shows:

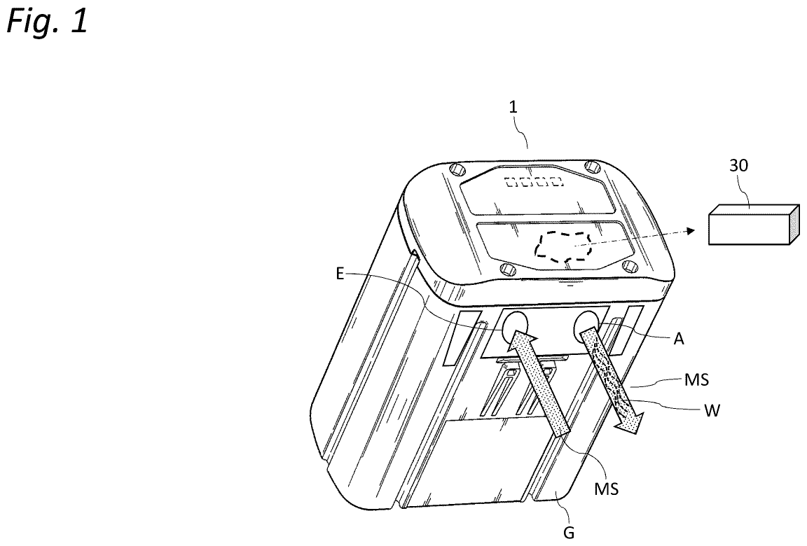

FIG. 1 a first embodiment of the energy supply device according to the present invention in a perspective view;

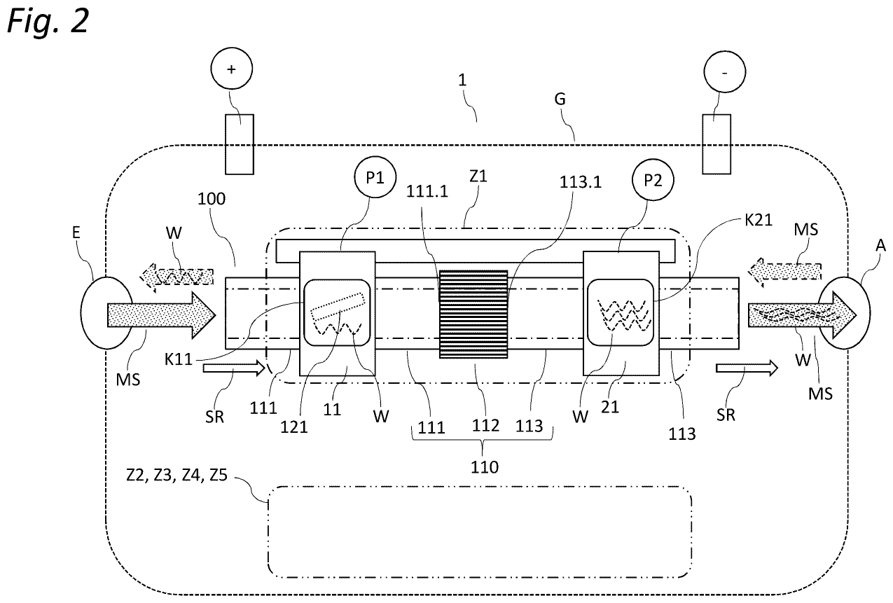

FIG. 2 a schematic illustration of the energy supply device from FIG. 1 with a cell unit on which the tempering apparatus of the energy supply device is arranged for tempering the cell unit, with further cell units being illustrated schematically;

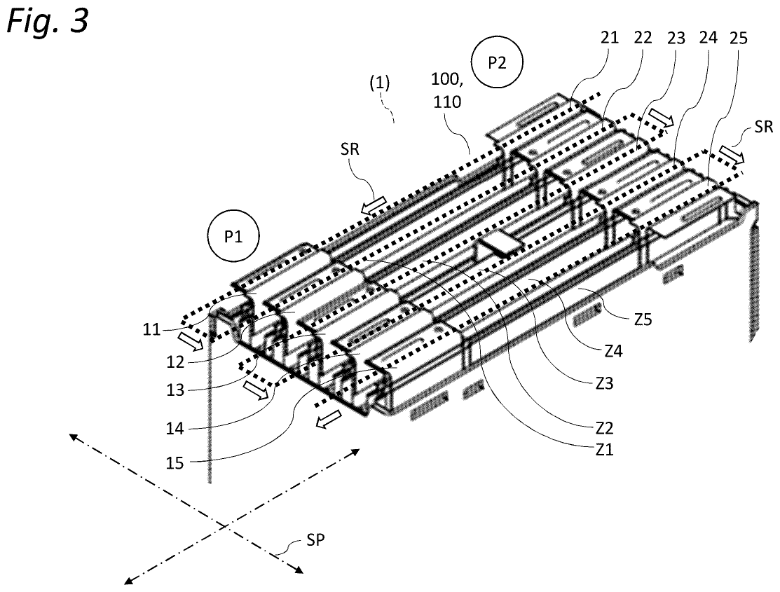

FIG. 3 the cell units from FIG. 2 in a state arranged relative to one another in a perspective view;

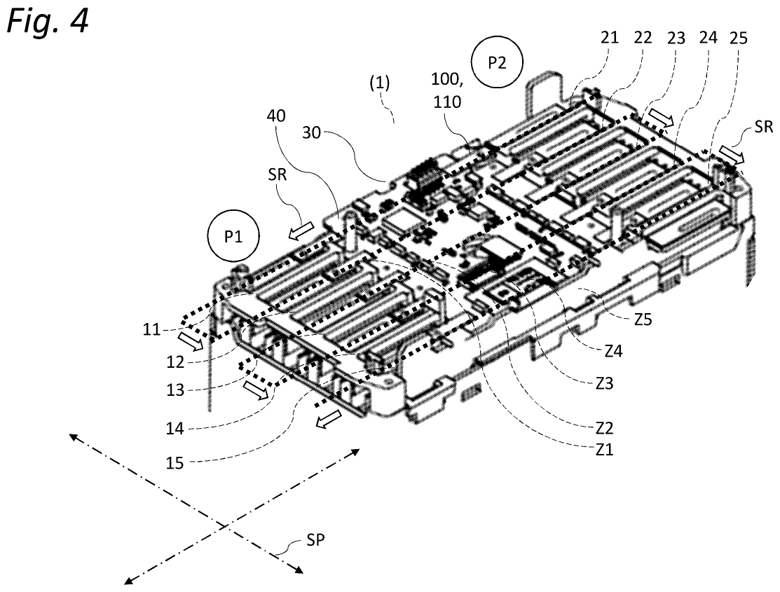

FIG. 4 the cell units from FIG. 3 in connection with a charge management unit of the energy supply device mounted via a carrier material structure in a perspective view;

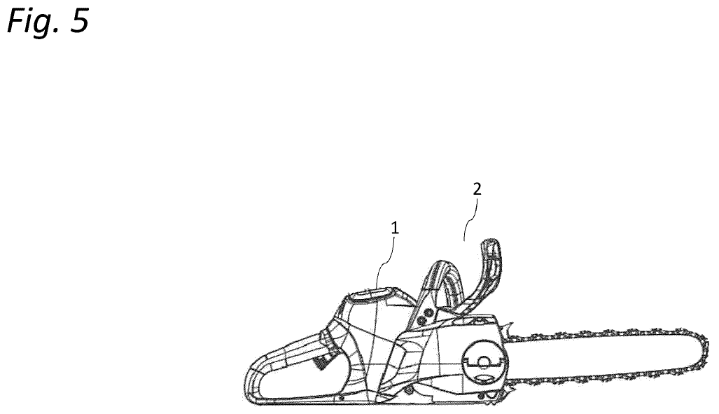

FIG. 5 an example of an electric tool that can be operated with the energy supply device according to the present invention in an operating state.

Identical or functionally equivalent devices, units, sections, or elements are marked with the same reference signs in the figures. For the sake of clarity, reference is also made in part to the description of other embodiments and/or figures in order to avoid repetition.

The following detailed description of the embodiments shown in the figures serves to provide further illustration or clarification and is not intended to limit the scope of the present invention in any way.

FIG. 1 shows a first embodiment of the energy supply device 1 according to the present invention in a perspective view.

The energy supply device 1 is a separate and/or independent device 1 for storing electrical energy during a charging process and/or for delivering electrical energy during a discharging process. The energy supply device 1 is configured as an electrical energy source for an electric tool 2 for supplying electrical energy to the electric tool 2.

The electric tool 2 can be a mobile, portable, manually operated, self-sufficient (mains-independent) and/or motor-driven electric tool 2.

FIG. 5 shows an example of an electric tool 2 in the form of an electric motor-operated chainsaw 2 for illustrative purposes. The energy supply device 1 is exchangeably accommodated in a compartment of the electric tool 2, in particular by means of an installation process in the form of an installation process in an installation direction.

The energy supply device 1 is formed as a mobile, portable, manually tool-free mountable and demountable, and/or exchangeable battery pack 1. The energy supply device 1 comprises the housing G for accommodating, integrating, and/or arranging respective devices, units, and elements of the energy supply device 1.

The energy supply device 1 comprises a plurality of cell units, of which the cell units Z1, Z2, Z3, Z4, Z5 are shown and labelled accordingly in the further FIGS. 2, 3, and 4. The cell units Z1, Z2, Z3, Z4, Z5 are also referred to as “battery cells” or, abbreviated, as “cells.” The cell units Z1, Z2, Z3, Z4, Z5 can be combined into several modules and, depending on the configuration, can be electrically connected to each other, for example, in the form of a series connection and/or a parallel connection. The cell units Z1, Z2, Z3, Z4, Z5 are arranged inside the housing G.

The energy supply device 1 comprises a charge management unit 30, which is configured in particular for monitoring a charging process. During a charging process, the charge management unit 30 is configured for distribution or adjustment, in particular for controlling and/or for regulating, a supplied charging current to the cell units Z1, Z2, Z3, Z4, Z5. In addition or alternatively, the charge management unit 30 is configured during a discharging process for drawing, in particular for controlling and/or regulating, a discharging current (stored charging current) from the cell units Z1, Z2, Z3, Z4, Z5.

It is understood that the energy supply device 1 comprises further devices, units, and/or elements, and/or is characterized by further devices, units, and/or elements, for example a display unit and/or at least one contact element for forming an electrical connection with a contact element of a charging device assigned as a counter contact element. For reasons of clarity, further devices, units, and/or elements are hidden, not visible, and/or not marked.

The energy supply device 1 can be formed in particular for carrying out a fast charging process with comparatively high charging currents and/or C-rates/charging rates. In order to be able to carry out such charging processes, the energy supply device 1 according to the invention is characterized by a tempering control concept by means of which an active tempering and thus an active thermal management can be realized using a medium flow MS for the transport of heat W.

By means of a generated medium flow MS, for example by means of a pump on a correspondingly formed charging device, heat W generated within the energy supply device 1, in particular at the cell units Z1, Z2, Z3, Z4, Z5, can, for example, be removed from the energy supply device 1 before, during and/or after a charging process, in order to set a respective defined temperature in the energy supply device 1. In addition or alternatively, it is also possible to introduce heat, i.e., a quantity of heat, into the energy supply device 1 by means of the medium flow MS in order to set a respective defined temperature in the energy supply device 1. In other words, both cooling and heating of the energy supply device 1 can be realized.

The medium flow MS can in particular be a flow of a flowable and/or liquid medium.

The medium can be based on water or oil, for example. Alternatively, the medium of the medium flow MS can also be a gaseous medium, for example air. The medium of the medium flow can be an essentially incompressible medium or a compressible medium. In particular, the medium flow MS is configured to absorb heat W and/or to deliver heat W. In other words, the medium flow MS serves for transferring and for transporting heat W. With a medium flow MS with a liquid medium, comparatively large temperature ranges can be covered, which is accompanied by a respective volume work of the medium flow MS.

For thermal interaction between the energy supply device 1 and a medium flow MS, a passage opening E and a passage opening A are formed at the housing G. The passage opening E serves for introduction (feeding) of the medium flow MS into the housing G. The passage opening A serves for dissipating (removing) the medium flow MS from the housing G. In other words, the passage opening E is an inlet opening and the passage opening A is an outlet opening. The medium flow MS can be guided in respective lines toward and away from the energy supply device 1.

In FIG. 1, the removal of heat W from the energy supply device 1 during a charging process, and the associated generation of heat W at the cell units Z1, Z2, Z3, Z4, Z5, is illustrated by way of example, whereby a medium flow MS flows into the housing G via the passage opening E and a heated medium flow MS flows out of the housing G via the passage opening A. Alternatively, it is possible that the medium flow MS flows into the housing G via the passage opening A, and that a heated medium flow MS flows out of the housing G via the passage opening E.

Alternatively, with a corresponding configuration of the energy supply device 1, the medium flow MS can flow into the housing G via a single passage opening and, after a defined period of time, be extracted again via the passage opening.

The transfer of the heat W generated in and/or at the cell units Z1, Z2, Z3, Z4, Z5 to the medium flow MS is realized according to the invention by means of a tempering apparatus 100 of the energy supply device 1, which will be described in more detail below with reference to the further figures.

FIG. 2 shows a schematic illustration of the energy supply device 1 from FIG. 1 with the cell unit Z1 highlighted, on which the tempering apparatus 100 for tempering the cell unit Z1 by means of the medium flow MS is arranged. The other cell units Z2, Z3, Z4, Z5 are shown schematically for reasons of clarity.

The cell unit Z1 as well as the other cell units Z2, Z3, Z4, Z5 are each realized in the form of so-called pouch cells and are therefore characterized by a plate-shaped and/or flat form. The cell units Z1, Z2, Z3, Z4, Z5 represent comparatively light, flexible, and highly energy-efficient cell units Z1, Z2, Z3, Z4, Z5. Each of the cell units Z1, Z2, Z3, Z4, Z5 can be formed, for example, on the basis of one of the following electrical storage technologies: lithium-ion technology, lithium-polymer technology, lithium-metal technology (e.g., lithium-manganese technology), lithium-iron-phosphate technology, Lithium-titanate technology, sodium-ion technology. Furthermore, it is possible that each or at least one cell unit Z1, Z2, Z3, Z4, Z5 comprises a liquid or solid electrolyte.

In the following, the arrangement of the cell unit Z1 in conjunction with the tempering apparatus 100 is described in more detail, which can apply or does apply correspondingly to the further cell units Z2, Z3, Z4, Z5.

The cell unit Z1 comprises the first connection element 11 and the second connection element 21. The first connection element 11 and the second connection element 21 each serve for providing an electrical potential P1, P2 and/or for transmitting electrical energy during a charging process or during a discharging process. In other words, the first connection element 11 and the second connection element 21 each represent a tab of the cell unit Z1. The connection elements 11, 12 form the electrical contacts which protrude from the cell unit Z1 starting from the anode and cathode of the cell unit Z1 and via which an electrical connection with the cell unit Z1 can be realized. The connection elements 11, 21 are made of an electrically conductive material, in particular a metallic material. The electrically conductive material can comprise, for example, aluminum or an aluminum alloy.

Alternatively, other electrically conductive materials can also be used to form the connection elements 11, 21, depending on the configuration of the cell unit Z1.

The connection elements 11, 12 are each formed at least in sections plate-shaped and/or essentially flat and/or angled, whereby corresponding contact surfaces for transmitting electrical energy and for transferring heat W from the cell unit Z1 or into the cell unit Z1 can be realized.

For realizing an (active) thermal management for the cell unit Z1, the energy supply device 1 according to the invention comprises the tempering apparatus 100 for tempering, in particular cooling, the cell unit Z1 by means of the medium flow MS in at least one channel 110 (hereinafter abbreviated as “channel 110”). The transfer of heat W is effected by the movement of the medium flow MS by means of convection, in particular in the form of forced convection. The tempering is effected in particular via the connection elements 11, 12, since these are formed of a material which is configured for transferring heat W. It is also possible that a quantity of heat can be transferred into and/or to the cell unit Z1, i.e. introduced, by means of the tempering apparatus 100 and via the medium flow MS in order to heat the cell unit Z1. The tempering can, in the context of the present invention, also comprise or relate to heating.

The channel 110 comprises several channel sections 111, 112, 113 and is configured to guide the medium flow MS along a flow direction SR. The channel 110 and, accordingly, the channel sections 111, 112, 113 can, for example, be formed in sections in a tubular, pipe-shaped and/or shaft-shaped manner. The channel sections 111, 112, 113 can, for example, each be characterized by an essentially round, oval, square, or rectangular flow cross-section for the medium flow MS. For example, the channel sections 111, 112, 113 can be characterized by a flow cross-sectional diameter between approximately 5 millimeters and approximately 10 millimeters.

The channel 110 can be formed accordingly, depending on the configuration of the cell unit Z1 and further cell units Z2, Z3, Z4, Z5, in particular depending on the respective connection elements 11, 21 (see also the further FIGS. 3 and 4), in order to contact the connection elements 11, 21 on respective sides and associated contact surfaces for the transfer of heat W.

The tempering apparatus 100 forms, in each case in a thermally conductive manner and at a first location a first coupling K11 with the first connection element 11 and at a second location a second coupling K21 with the second connection element 21.

In the illustrated embodiment of the energy supply device 1, the first coupling K11 is realized between the first connection element 11 and the channel section 111.

The second coupling K21 is realized between the second connection element 21 and the channel section 113. The first connection element 11 can, for example, be connected to the channel section 111, i.e., to a corresponding outer contact surface of the channel section 111, via an essentially material bonded connection, for example in the form of an adhesive connection. Accordingly, the second connection element 21 can be connected to the channel section 113. In other words, the first coupling K11 and/or the second coupling K21 can each comprise an essentially material bonded connection, which is produced, for example, by an adhesive process. Alternatively, the connection is also possible by a welding process or by a soldering process in order to form the respective coupling K11, K21.

In order to realize an optimum transfer of heat W from cell unit Z1 or into cell unit Z1, the channel sections 111 and 113 are, corresponding to the connection elements 11, 21 assigned to them, each formed of a metallic material with respective thermal conductivities.

However, the channel section 112 is formed as an insulating section 112 or represents an insulating section 112. The insulating section 112 extends along the flow direction SR and/or defines the flow direction SR in some cases. The insulating section 112 is produced from an electrically insulating material, i.e., an insulating material with inherent electrical insulating properties and resulting insulating capabilities. The insulating section 112 can, for example, be formed on the basis of an electrically insulating material in the form of a plastic. In other words, the insulating section 112 is configured to be electrically insulating. The insulating section 112 can, in particular, be formed integrally in one piece, for example by at least one of the following processes: a casting process, an injection process, a sintering process, a 3D printing process.

The electrically insulating material can additionally be a thermally insulating material. This can, for example, avoid a (re)transfer of heat W to be removed through the insulating section 112 at the location within the energy supply device 1 where the insulating section 112 is located.

The insulating section 112 can be formed, along the flow direction SR, sectionally variable shape, in particular essentially reversibly deformable, in order, for example, to essentially balance and/or compensate a volume work of the medium flow MS when a corresponding medium is used.

The insulating section 112 extends along the flow direction SR between the first coupling K11 and the second coupling K21 with a defined length. The insulating section 112 can be arranged and/or formed to change, in particular to deflect, the flow direction SR, for example to take into account respective configurations of the cell unit Z1 and/or further cell units Z2, Z3, Z4, Z5.

The tempering apparatus 100 is therefore configured to galvanically separate from each other the first connection element 11 and the second connection element 21 between the first coupling K11 and the second coupling K21 by means of the insulating section 112 of the channel 110, in order to avoid electrical contacting of the first connection element 11 and the second connection element 21. In other words, this allows the potentials P1 and P2 to be separated, i.e., a potential separation can be realized, primarily to avoid the occurrence of short circuit.

It is possible that a flow cross-section for the medium flow MS of the insulating section 112 varies along the at least one flow direction SR, for example, decrease in sections and/or increase in sections, in order to at least passively influence the medium flow MS at defined locations depending on the configuration of the cell unit Z1, in particular with regard to a flow velocity and/or a dynamic pressure of the medium flow MS, whereby the transfer of heat W can be influenced. For example, a flow cross-section of the insulating section 112, which is arranged between two adjacent cell units Z1, Z2, can be smaller than a flow cross-section of an insulating section 112, which is arranged outside the cell units Z1, Z2.

It is possible that the flow direction SR for the medium flow MS can change and/or reverse. The flow direction SR can be defined by the course of the channel 110 and thus be predetermined. The flow direction SR can be such that the medium flow MS is directed from the first coupling K11 downstream toward the second coupling K21 or vice versa.

As can be seen from the illustration in FIG. 2, the insulating section 112 is connected, against the flow direction SR upstream and in the flow direction SR downstream, in each case by means of an essentially material bonded connection to a respective connection section 111.1 and 113.1 of the respective associated channel section 111 and 113. The essentially material bonded connection can be formed by at least one of the following processes: a casting process, an injection process, an adhesive process, a welding process, a shrinking process, a curing process. It is additionally or alternatively possible that the insulating section 112, for example in pipe-shaped form, is connected to the respective channel section 111 and 113 by a plugging process and/or a pressing process.

The channel section 111 and/or the channel section 113 can each be configured to generate a turbulent medium flow MS along the flow direction SR in order to increase an absorption and/or removal of generated heat W at the respective connection element 11, 21. At least one guide element 121 for generating the turbulent medium flow MS can be arranged and/or formed within the respective channel section 111, 113. The at least one guide element 121 can extend in particular along the flow direction SR.

For example, four guide elements 121 can be arranged within a channel section 111, 113, which are characterized in a cross-sectional view of the channel section 111, 113 by a sectionally cross-shaped contour. It is also possible that a guide element 121 and a further guide element 121 are arranged and/or formed along the flow direction SR opposite to each other and/or offset relative to each other. The at least one guide element 121 can be formed as one of the following: a fin, a lamella, a blade. In particular, the at least one guide element 121 can be arranged within the channel 100, i.e., within the respective channel section 111, 113, each upstream in front of the location of the first coupling K11 and/or the second coupling K21. It is also possible, that the at least one guide element 121 is arranged opposite the location of the coupling K11 and/or K21. It is understood that the at least one guide element 121 is associated with a defined increase in surface area, by means of which the heat transfer to the medium flow MS can be further increased.

FIG. 3 shows the cell units Z1, Z2, Z3, Z4, Z5 from FIG. 2 in a perspective view, wherein the first connection elements 11, 12, 13, 14, 15 and the second connection elements 21, 22, 23, 24, 25 are visible. Furthermore, the location of the cell units Z1, Z2, Z3, Z4, Z5 and thus their respective position and orientation can be clearly seen from the illustration in FIG. 3. The cell units Z1, Z2, Z3, Z4, Z5 are arranged adjacent to one another in a stacking direction SP.

For illustrative purposes, the tempering apparatus 100 is schematically indicated by a dotted line, which in particular characterizes a location and/or a course of the channel 110 and, associated with this, the flow direction SR for the medium flow MS. The channel 110 for guiding the medium flow MS is characterized by a meandering course. Depending on the form and arrangement of the cell units Z1, Z2, Z3, Z4, Z5, the channel 110 of the tempering apparatus 100 can also be characterized by other configurations, for example by the following: comb-shaped (with two central channel sections for dividing and then recombining the medium flow), spiral-shaped, zigzag-shaped, wave-shaped, and/or stepped.

Between the first and second connection elements 11, 21; 12, 22; 13, 23; 14, 24; and 15, 25 of each respective cell unit Z1, Z2, Z3, Z4, Z5, an insulating section 112 of the channel 110 is arranged in each case. It is understood that the channel 110 is divided into several channel sections, which also contribute to changing the flow direction SR.

FIG. 4 shows the cell units Z1, Z2, Z3, Z4, Z5 from FIG. 3 in a perspective view in connection with an assembled charge management unit 30 of the energy supply device 1. The charge management unit 30 is arranged on a carrier material structure 40, which can be formed in sections as a printed circuit board formed of a corresponding material. The carrier material structure 40 can be formed on the basis of a substantially dimensionally stable resin material. The carrier material structure 40 can be produced by at least one casting process, at least one injection process, and/or at least one curing process, wherein the channel 110 and, in particular, the insulating section 112 are arranged and/or embedded within the carrier material structure 40 together with the couplings K11, K21.

By means of the tempering apparatus 100 and the medium flow MS in the channel 110, for example, cooling of the charge management unit 30 can additionally be realized, which characterizes the present energy supply device 1.

The present invention is not limited to the embodiments described above. Rather, a variety of variants and modifications are possible which also make use of the inventive concept and therefore fall within the scope of protection. In particular, the present invention also claims protection for the subject matter and features of the dependent claims independently of the claims referred to.

### LIST OF REFERENCE SIGNS

1 energy supply device
2 electric tool
11 connection element
12 connection element
13 connection element
14 connection element
15 connection element
21 connection element
22 connection element
23 connection element
24 connection element
25 connection element
30 charging management unit
40 carrier material structure
100 tempering apparatus
110 channel
111 channel section
111.1 connection section
112 channel section/insulation section
113 channel section
113.1 connection section
A passage opening
E passage opening
G housing
K11 coupling
K21 coupling
MS medium flow
P1 potential
P2 potential
SR flow direction
SP stacking direction
W heat
Z1 cell unit
Z2 cell unit
Z3 cell unit
Z4 cell unit
Z5 cell unit

What is claimed is:

1. An energy supply device, comprising:
at least one cell unit for receiving and/or delivering electrical energy in an operating state of the energy supply device,
wherein the at least one cell unit comprises a first connection element and a second connection element, which are configured for transmitting electrical energy;
a tempering apparatus for tempering the at least one cell unit by means of a medium flow in at least one channel which is configured to guide the medium flow along at least one flow direction,
wherein the tempering apparatus forms, in each case in a thermally conductive manner, a first coupling with the first connection element and a second coupling with the second connection element, and
is configured to galvanically separate from each other the first connection element and the second connection element between the first coupling and the second coupling by means of at least one insulating section of the at least one channel, in order to avoid electrical contacting of the first and second connection elements.

2. The energy supply device according to claim 1, wherein the at least one insulating section is configured to be electrically insulating and/or extends along the at least one flow direction between the first coupling and the second coupling with a defined length.

3. The energy supply device according to claim 1, wherein the at least one insulating section is formed integrally in one piece on the basis of an electrically insulating material.

4. The energy supply device according to claim 1, wherein the at least one insulating section is formed to be sectionally variable in shape along the at least one flow direction in order to compensate for a volume work of the medium flow.

5. The energy supply device according to claim 1, wherein the at least one insulating section is arranged or formed to change the flow direction.

6. The energy supply device according to claim 5, wherein the at least one insulating section is formed curved.

7. The energy supply device according to claim 1, wherein a flow cross-section of the at least one insulating section varies along the flow direction in each case depending on an arrangement of the at least one cell unit relative to at least one further or adjacent cell unit.

8. The energy supply device according to claim 1, wherein the first coupling and/or the second coupling each comprise a material bonded connection.

9. The energy supply device according to claim 1, wherein the at least one insulating section is connected, against the flow direction upstream and/or in the flow direction downstream, in each case by means of a material bonded connection to a respective connection section of the at least one channel.

10. The energy supply device according to claim 1, wherein at least one channel section of the at least one channel is configured to generate a turbulent medium flow in order to increase an absorption and/or a removal of generated heat at the first connection element and/or at the second connection element.

11. The energy supply device according to claim 10, wherein at least one guide element for generating the turbulent medium flow is arranged and/or formed within the at least one channel, which extends along the flow direction.

12. The energy supply device according to claim 11, wherein four guide elements are arranged within the at least one channel, which are characterized in a cross-sectional view of the at least one channel by a sectionally cross-shaped contour.

13. The energy supply device according to claim 10, wherein the at least one guide element and at least one further guide element are arranged and/or formed along the flow direction opposite to each other and/or offset relative to each other.

14. The energy supply device according to claim 13, wherein the at least one guide element is formed as at least one of the following: a fin, a lamella, a blade.

15. The energy supply device according to claim 1, wherein the at least one channel and at least the first coupling and the second coupling are arranged and/or embedded within a carrier material structure, which is formed dimensionally stable, integrally one-piece and/or electrically insulating, or which is produced by at least one of the following processes: an injection process, a casting process, a curing process.

16. The energy supply device according to claim 1, wherein the energy supply device comprises a plurality of cell units, each with a first connection element and a second connection element,
wherein, depending on the arrangement of the respective first connection element and the respective second connection element, the at least one channel comprises, along the flow direction, in sections at least one of the following configurations: meandering, comb-shaped, spiral-shaped, zigzag-shaped, wave-shaped, stepped.

17. The energy supply device according to claim 1, wherein the energy supply device comprises a plurality of cell units, each with a first connection element and a second connection element, which are arranged in a stacking direction adjacent to each other to form a cell pack with opposing outer sides,
wherein the at least one channel is arranged and formed such that the flow direction runs from at least one centrally arranged cell unit to at least one of the outer sides.

18. A method for setting a temperature of an energy supply device, with at least one cell unit for receiving and/or delivering electrical energy in an operating state of the energy supply device, wherein the at least one cell unit comprises a first connection element and a second connection element, which are configured for transmitting electrical energy; and
with a tempering apparatus for tempering the at least one cell unit, which comprises at least one channel for guiding a medium flow along a flow direction, wherein the tempering apparatus forms, in each case in a thermally conductive manner, a first coupling with the first connection element and a second coupling with the second connection element and galvanically separates from each other the first connection element and the second connection element between the first coupling and the second coupling by means of at least one insulating section of the at least one channel,
wherein the medium flow is introduced into the at least one channel in order to dissipate generated heat of the first connection element and/or the second connection element by the medium flow along the flow direction or to introduce a quantity of heat in order to set a defined temperature of the energy supply device,
wherein the energy supply device is configured according to claim 1.
